(19) United States
(12) Patent Application Publication
(10) Pub. No.: US 2018/0245335 A1
(43) Pub. Date: Aug. 30, 2018

(54) INSULATING PANEL AND INSULATING ARRANGEMENT

(71) Applicant: WERNER SCHLÜTER, Iserlohn (DE)

(72) Inventor: WERNER SCHLÜTER, Iserlohn (DE)

(21) Appl. No.: 15/758,473

(22) PCT Filed: Sep. 14, 2016
(86) PCT No.: PCT/EP2016/071692

§ 371 Date: Mar. 8, 2018

(30) Foreign Application Priority Data
Sep. 16, 2015 (DE) 20 2015 104 913.7

(51) Int. Cl. E04B 1/90; B32B 27/12; B32B 5/02; B32B 5/18; B32B 5/24; B32B 7/12; B32B 5/32; B32B 27/30; B32B 27/06

(52) U.S. Cl. CPC E04B 1/90; E04B 1/762; B32B 5/024; B32B 5/022; B32B 5/18; B32B 5/245; B32B 7/12; B32B 5/32; B32B 27/302; B32B 27/065; B32B 2266/0228; B32B 2266/0278; B32B 2307/102; B32B 2307/304; B32B 2419/00; B32B 27/12

(57) ABSTRACT

Insulation panel or thermally and/or acoustically insulating a strike, in particular a building wall, comprising a first insulating layer that is made of plastic foam and defines an upper face of the insulation panel; the first insulating layer has outward-extending projections which are provided with undercuts and are spaced at regular intervals.

The present invention relates to an insulating panel for thermally and/or acoustically insulating a surface, in particular a building wall, comprising a first insulating layer that is made of plastic foam and defines an upper face of the insulating panel. Furthermore, the present invention relates to an insulating arrangement comprising a surface, a number of insulating panels of the type specified at the start which are fastened to the surface with their lower face and cover the surface, and a mortar layer which is applied to the upper face of the insulating panels. Moreover, the invention relates to an insulating panel of the type specified at the start for producing this type of insulating arrangement.

Insulating panels of the type specified at the start are known in a wide variety of embodiments in the prior art. They are used for, among other things, thermally and/or acoustically insulating surfaces, such as for example building walls. In the simplest embodiment insulating panels are produced in one part from plastic foam and have a level lower face and a level upper face. In order to insulate a building wall, in a first step the insulating panels are fastened to the latter, the fastening possibly taking place using an adhesive mortar and/or using dowels, to give just a few examples. In a further step, a first layer of a plaster mortar can then be applied to the insulating panels, which plaster mortar is then smoothed with a palette knife. A reinforcing grid is then pressed over the smoothed first plaster layer in order to stabilise the plaster layer. Next, an additional plaster layer is applied which can also be smoothed if so required.

A disadvantage of producing an insulating arrangement using insulating panels of the type described above is that this arrangement is very expensive.

On the basis of this prior art it is an object of the present invention to devise an insulating panel and an insulating panel arrangement with an alternative structure.

In order to achieve this object, the present invention devises an insulating panel of the type specified above which is characterised in that the first insulating layer has outward-extending projections which are provided with undercuts and are spaced at regular intervals. One essential advantage of projections formed in this way is that a mortar applied to the upper face of the insulating panel fills the gaps between the projections, and so also the undercuts, as a result of which mechanical fastening of the mortar to the projections or to the insulating panel is achieved. Accordingly, one can dispense with using an additional reinforcing grid, and so with respect to the prior art described at the start, one procedural step can be dispensed with. Accordingly, one can economise on effort and cost.

According to one embodiment of the present invention, the first insulating layer is produced from a thermoplastic material. Such thermoplastic materials have very good insulating properties.

Advantageously, the first insulating layer is produced from polystyrene, polyurethane or Piocelan, in particular by extruding or foaming in a mould, by means of which very good results have been achieved within the framework of trials. In particular, the material density can be set specifically when producing the first insulating layer, and so the desired thermal and/or acoustic insulating properties and/or the compressive stability of the first insulating layer can be achieved easily.

Advantageously, at least 4 projections per dm² are provided, preferably at least 10 projections per dm². Accordingly, very good fastening of the mortar to the upper face of the insulating panel can be guaranteed.

According to one embodiment of the present invention, as viewed from above, the projections have a polygonal form, in particular a quadratic or octagonal form, in the latter case the projections preferably having four longer side edges lying opposite one another in pairs, and four shorter side edges lying opposite one another in pairs, the shorter side edges advantageously having projections arranged adjacent to one another.

Preferably, the insulating panel has at least one additional insulating layer made of plastic foam, which insulating layer is preferably connected directly to the first insulating layer, the additional insulating layer differing from the first insulating layer with regard to the material and/or with regard to the material density. With this type of additional insulating layer, it can be ensured that the insulating panel has very good thermal insulating properties and/or very good acoustic insulating properties and/or very good compressive stability.

The additional insulating layer is preferably produced from a thermoplastically processed synthetic material.

Advantageously, the additional insulating layer is produced from polystyrene, in particular from extruded polystyrene or polystyrene foamed in a mould.

The first insulating layer and the additional insulating layer can be produced separately from one another and then be connected to one another, for example using an adhesive. Preferably however, they are extruded together or are foamed together in an appropriate mould.

Preferably, the insulating panel has a vapour barrier layer which is produced in particular from a foil, preferably from a metal foil.

According to one embodiment of the present invention, the insulating panel has on its lower face lying opposite the upper face a fleece or fabric layer. This type of fleece or fabric layer, as an adhesion promoting layer, can facilitate and improve the fastening of the insulating panel according to the invention to a surface.

Preferably, the insulating panel has an overall height in the region of from 6 to 200 mm. Smaller overall heights are to be favoured, in particular in indoor areas. The larger overall heights are used first and foremost in outdoor areas, such as for example when insulating outer walls of buildings.

The projections advantageously have a height of no more than 8 mm, and so a very thin mortar layer is sufficient to completely cover the projections. Accordingly, only a small amount of mortar material is required for the production of an insulating arrangement.

In order to achieve the object specified at the start, the present invention further devises an insulating arrangement comprising a surface, a number of insulating panels according to the invention which are fastened by their lower face to the surface and cover the latter, and a mortar layer which is applied to the upper face of the insulating panels, the mortar filling the undercuts of the projections and covering the projections.

Preferably, the surface is formed by a building wall, the mortar being a plaster mortar.

According to one preferred embodiment of the insulating arrangement according to the invention the insulating panels are fastened to the surface using an adhesive, in particular using an adhesive mortar and/or using dowels.

Furthermore, the present invention proposes using an insulating panel according to the invention to produce an insulating arrangement according to the invention.

Further features and advantages of the present invention become clear from the following description of an insulating panel according to one embodiment of the present invention with reference to the attached drawings. These show as follows:

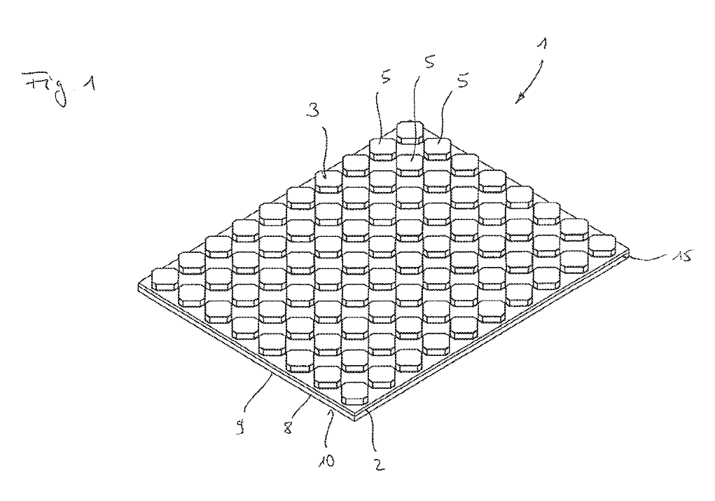

FIG. 1 a schematic perspective view of an insulating panel according to one embodiment of the present invention;

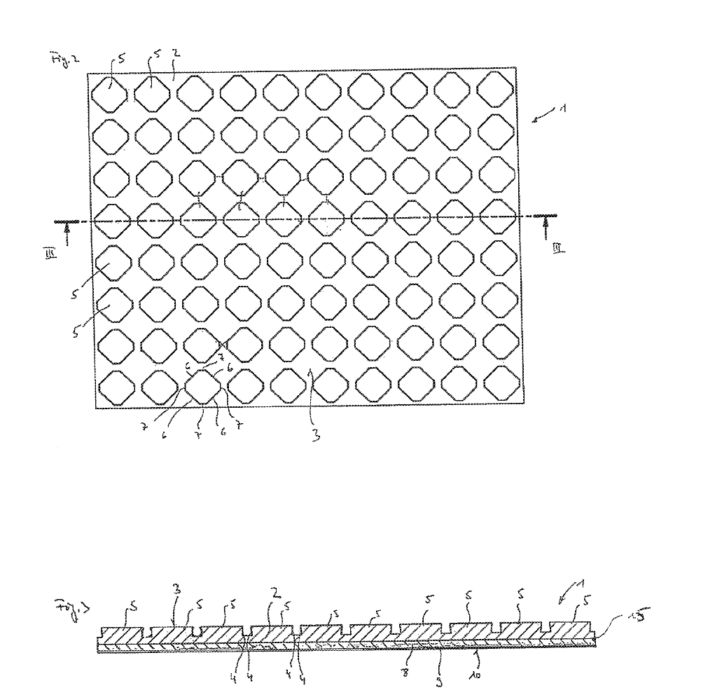

FIG. 2 a top view of the insulating panel shown in FIG. 1;

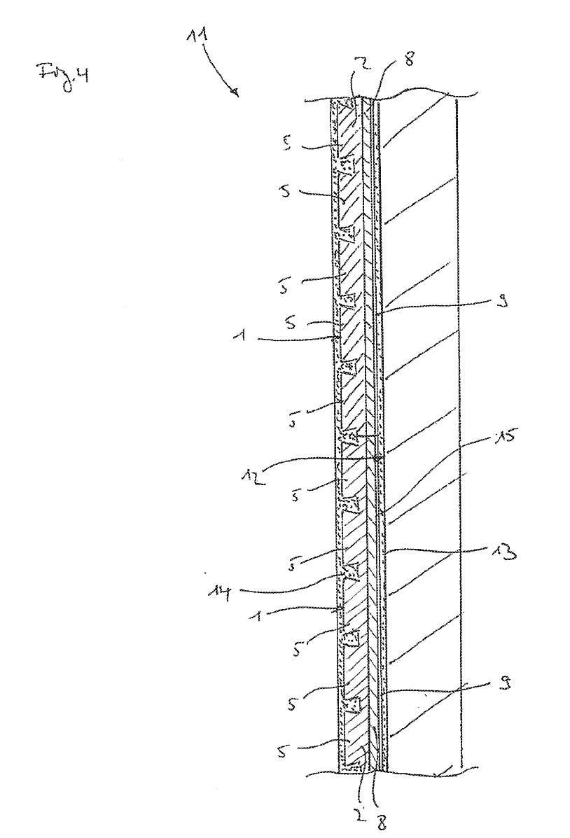

FIG. 3 a sectional view of the insulating panel shown in FIG. 1 along line in FIG. 2; and

FIG. 4 a schematic sectional view of an insulating arrangement which is produced using a number of the insulating panels shown in FIGS. 1 to 3.

FIGS. 1 to 4 show an insulating panel 1 according to one embodiment of the present invention which serves to thermally and acoustically insulate a surface, in particular a building wall. The insulating panel 1 comprises a first insulating layer 2 which is produced from plastic foam and defines an upper face 3 of the insulating panel 1. More precisely, in the present case the first insulating layer 2 is produced from extruded polystyrene or polystyrene foamed in a mould. Alternatively however, polyurethane or Piocelan, for example, can also be used. The first insulating layer 2 comprises a plurality of outward-extending projections 5 provided with circumferential or partially circumferential undercuts 4, which projections are respectively octagonal in form with four longer side edges 6 lying opposite one another in pairs and four shorter side edges 7 lying opposite one another in pairs. The projections 5 are provided in a regular arrangement. In the present case the projections 5 form a matrix defined by rows and columns with at least 4 projections per dm². However, it should be clear that other arrangements may basically also be chosen. In the present case the first insulating layer 2 has an overall height h₁ of 9 mm, the projections 5 having a height hᵥ of 6 mm. Furthermore, the insulating panel 1 comprises a second insulating layer 8 which is arranged beneath the first insulating layer 2 and is fastened to the latter. The second insulating layer 8, which in the present case has a totally level lower face, is likewise produced from plastic foam, in the present case from extruded polystyrene or polystyrene that has been foamed in a mould, the material density of the additional insulating layer 8 differing from the material density of the first insulating layer 2. The first insulating layer 2 and the additional insulating layer 8 can be produced separately from one another and are then connected to one another by material engagement or using an appropriate adhesive.

In the present case, however, the first insulating layer 2 and the additional insulating layer 8 have been extruded together or have been foamed simultaneously in a common mould. The additional insulating layer 8 has a height h₂ of 3 mm. A fleece or fabric layer 9, which defines a lower face 10 of the insulating panel 1, is arranged and fastened beneath the additional insulating layer 8.

It should be pointed out that, although the insulating panel 1 shown in FIGS. 1 to 3 has a first insulating layer 2, a second insulating layer 8 and a fleece or fabric layer 9, it may also consist exclusively of a first insulating layer 2 with a preferably completely level lower face, or only of a first insulating layer 2 with a preferably completely level lower face and a fleece or fabric layer 9 fastened to the latter. Furthermore, the insulating panel 1 may optionally be provided with additional layers, such as for example with a third insulating layer, a vapour barrier layer 15 produced from a metal foil and which is disposed in particular between the insulating layer 8 and the fleece or fabric layer 9 or, if no insulating layer 8 is provided, between the first insulating layer 2 and the fleece or fabric layer 9, or the like, to give just a few examples. The arrangement of two insulating layers 2 and 8, which differ from one another with regard to the material and/or with regard to the material density and/or with regard to the compressive stability, is advantageous in that the first insulating layer 2 can be formed, for example, such that it has particularly good thermal insulating properties, and in that the second insulating layer 8 can be formed such that it gives rise to particularly good acoustic insulating properties, or vice versa. The optional fleece or fabric layer 9 serves as an adhesion-promoting layer so that the insulating panel 1 can be fastened to a surface more easily and better using an adhesive, in particular using an adhesive mortar. The projections 5 preferably have a height of no more than 8 mm, and so only a small amount of mortar material is required to cover the projections 5 if a mortar layer is applied to the upper face 3 of the insulating panel 1, as will be explained in more detail below. The overall height H of the insulating panel can be in the range of from 8 to 200 mm depending on the requirements.

FIG. 4 shows an insulating arrangement 11 with a surface 12 which in this case is a building wall. A plurality of insulating panels 1 are fastened to the surface 12 using an adhesive mortar 13 such that they completely cover the surface 12. Here the adhesive mortar 13 grips in the fleece or fabric layer 9, as a result of which very good fastening is achieved. The adhesive mortar 13 can be applied, for example, in the form of beads and/or lumps of mortar or over the entire surface using a toothed trowel. In addition to the adhesive mortar 13, the insulating panels 1 may also be secured to the surface 12 using dowels (not detailed).

Insulating panels 1 that are arranged one over the other are to be arranged offset to one another, as a result of which very good stability is achieved. A mortar layer 14 is applied to the upper faces 3 of the insulating panels 1, the mortar filling the undercuts 4 of the projections 5 and covering the projections 5. The mortar may be in particular an interior or exterior plaster mortar. By virtue of the projections 5 provided with the undercuts 4, a very good mechanical connection between the mortar layer 14 and the insulating panel 1 is achieved, for which reason one can dispense with the provision of an additional reinforcing grid.

Although the invention has been illustrated and described in detail by the preferred exemplary embodiment, the invention is not restricted to the disclosed examples, and other variations may be derived from these by the person skilled in the art without straying from the scope of protection of the invention.

### LIST OF REFERENCE NUMBERS

1 insulating panel
2 first insulating layer
3 upper face
4 undercut
5 projection
6 longer side edge
7 shorter side edge
8 insulating layer
9 fleece or fabric layer
10 lower face
11 insulating arrangement
12 surface
13 adhesive mortar
14 mortar layer
15 vapour barrier layer

1. An insulating panel (1) for thermally and/or acoustically insulating a building wall (12), comprising:
a first insulating layer (2) that is made of plastic foam and defines an upper face (3) of the insulating panel (1), wherein
the first insulating layer (2) has outward-extending projections (5) which are provided with undercuts (4) and are spaced at regular intervals.

2. The insulating panel (1) according to claim 1, wherein the first insulating layer (2) is produced from a thermoplastic material and/or from polystyrene, polyurethane or Piocelan, and is produced by extruding or foaming in a mould.

3. The insulating panel (1) according to claim 1 wherein at least 4 projections (5) per dm² are provided, preferably at least 10 projections (5) per dm².

4. The insulating panel (1) according to claim 1, wherein, as viewed from above, the projections (5) have a quadratic or octagonal form, in the latter case the projections (5) having four longer side edges (6) lying opposite one another in pairs, and four shorter side edges (7) lying opposite one another in pairs, the shorter side edges (7) advantageously having projections (5) arranged adjacent to one another.

5. The insulating panel (1) according to claim 1, further comprising at least one additional insulating layer (8) made of plastic foam, which insulating layer is preferably connected directly to the first insulating layer (2), the additional insulating layer (8) differing from the first insulating layer (2) with regard to the material and/or with regard to the material density.

6. The insulating panel (1) according to claim 5, wherein the additional insulating layer (8) is produced from a thermoplastically processed synthetic material and/or from extruded polystyrene or polystyrene foamed in a mould.

7. The insulating panel (1) according to claim 1, further comprising a vapour barrier layer (15) which is produced from a metal foil.

8. The insulating panel (1) according to claim 1, further comprising a fleece or fabric layer having a lower face (10) lying opposite the upper face (3).

9. The insulating panel (1) according to claim 1, wherein the panel has an overall height (H) from about 6 mm to about 200 mm.

10. The insulating panel (1) according to claim 1, wherein the projections (5) have a height (hᵥ) of no more than about 8 mm.

11. An insulating arrangement (11) comprising a plurality of insulating panels (1), each insulating panel (1) comprising:
a first insulating layer (2) that is made of plastic foam and defines an upper face (3) of the insulating panel (1),
the first insulating layer (2) has outward-extending projections (5) which are provided with undercuts (4) and are spaced at regular intervals; wherein
each of the plurality of insulating panels (1) are fastened by their lower face (10) to the surface (12) and cover the surface (12), and
a mortar layer (14) which is applied to the upper face (3) of the insulating panels (1), the mortar layer (14) filling the undercuts (4) of the projections (5) and covering the projections (5).

12. The insulating arrangement (11) according to claim 11, wherein the mortar layer (14) is a plaster mortar layer.

13. The insulating arrangement (11) according to claim 11, wherein the insulating panels (1) are fastened to the surface (12) using an adhesive mortar (13) and/or using dowels.

14. A method of forming an insulating panel (1), comprising:
obtaining a plurality of insulating panels (1), each insulating panel having a lower face (10) and including:
a first insulating layer (2) that is made of plastic foam and defines an upper face (3) of the insulating panel (1); and
the first insulating layer (2) having outward-extending projections (5) which are provided with undercuts (4) and are spaced at regular intervals;
fastening each of the plurality of insulating panels (1) by the lower faces (10) of the insulating panels to a surface (12) to thereby cover the surface (12), and
applying a mortar layer (14) to the upper faces (3) of the insulating panels (1), the mortar layer (14) filling the undercuts (4) of the proiections (5) and covering the proiections (5).
